(19) United States
(12) Patent Application Publication
(10) Pub. No.: US 2024/0348490 A1
(43) Pub. Date: Oct. 17, 2024

(54) ACCESS POINT FAULT AND ERROR CODE COMMUNICATION

(71) Applicant: HEWLETT PACKARD ENTERPRISE DEVELOPMENT LP, Spring, TX (US)

(72) Inventors: KEVIN L. MARSHALL, Spring, TX (US); AARON SCOTT, Spring, TX (US)

(21) Appl. No.: 18/298,607

(22) Filed: Apr. 11, 2023

(51) Int. Cl. H04L 41/0631; H04L 41/0654

(52) U.S. Cl. CPC H04L 41/0631; H04L 41/0654; H04W 84/12

(57) ABSTRACT

Systems and methods are provided for determining a root cause of an access point (AP) failure or error even with the AP is unable to communicate or interact with a network management system (NMS). The AP may transmit health information (that can reflect the cause of the AP failure) in an information element (IE) that can be included in a beacon frame or other data frame transmitted by the AP. The IE can be relayed to the NMS by one or more APs that neighbor the failed or errant AP or a client device capable of consuming the IE.

### BACKGROUND

Access points (APs) typically interact with an on-premises or cloud-based network management system (NMS) for provisioning, configuration, and monitoring purposes. APs seeking to attach to a network, e.g., “new” APs, discover their associated NMS in order to communicate with, and receive an appropriate configuration. APs that are already operational in a network, e.g., “running”/“existing” APs, maintain communications with their NMS to receive configuration updates, and for transmitting telemetry information/data to the NMS. NMSs may also host additional services that APs may rely on for radio frequency (RF) management, encryption key management, etc.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 illustrates an example network deployment in which examples of the disclosed technology may be applied.

FIG. 2 illustrates an example information element containing AP health information in accordance with examples of the disclosed technology.

FIGS. 3A and 3B illustrates an example method for determining bit values assigned to fields of the example information element of FIG. 2.

FIGS. 4A and 4B illustrate another example method for determining bit values assigned to fields of the example information element of FIG. 2.

FIG. 5 illustrates an example fault and error code communication scenario in which examples of the disclosed technology may be used.

FIG. 6 illustrates another example fault and error code communication scenario in which examples of the disclosed technology may be used.

FIG. 7 is a block diagram of an example computing component for identifying and providing AP health information signifying AP failure root causes in accordance with one example of the disclosed technology.

FIG. 8 is an example computing component that may be used to implement various features of embodiments described in the present disclosure.

The figures are not exhaustive and do not limit the present disclosure to the precise form disclosed.

### DETAILED DESCRIPTION

An enterprise, such as a business, an organization, or an individual, may utilize various network devices or elements in conducting enterprise operations. One such network device is a wireless access point (AP). An AP is a network device that allows wireless client devices to connect to a wireless local area network (WLAN). Enterprise deployments (i.e., network deployments of one or more WLANs across a large geographical area, typically associated with a single business/enterprise such as a large corporate office, airport, hospital, etc.) include multiple physical APs strategically located across the enterprise.

As alluded to above, APs typically rely on interactions with an NMS in order to become operational/begin communicating with other APs, client devices/stations, or other network devices. APs also interact with an NMS in order to implement any changes to the AP's operation, or the AP itself, for example. Moreover, APs may interact with an NMS to effectuate the transmission of telemetry data, e.g., state of an AP, operating condition of one or more radios of an AP, airtime utilization, memory utilization, channel changes, etc. APs may also interact with an NMS for purposes of exchanging data, instructions, and so on in the context of NMS-hosted services, such as RF management, or key management, to name a few.

Situations can arise, where an AP is unable to discover its NMS, or where an AP cannot communicate with its NMS. In either case, the cause of this inability to interact with an NMS is typically unknown. In the case of newly deployed APs, for example, such newly deployed APs will not be active or present/registered in the NMS yet, in which case, an NMS administrator cannot be alerted of a problem or issue with such newly deployed APs. Indeed, problems with newly deployed APs would have to be identified by an installer of the newly deployed AP, who would then notify an administrator to initiate troubleshooting. The AP may also not have physical layer or network connectivity to permit remote access by the NMS to determine the cause (also referred to as root or root cause) of an issue with the AP. If an existing/running AP goes down, an administrator can be alerted by the NMS that an issue with the AP exists, but will not be privy as to why the AP is unable to communicate its state to the NMS. As with the previous example, the existing AP may not have physical layer or network connectivity that permits remote access to the existing AP to determine a root cause. In both scenarios, the APs have the necessary state information to aid in root cause determinations, but are unable to communicate this information to a relevant entity or system, e.g., an administrator or the NMS. Additionally, APs are generally installed in ceilings or inaccessible places making direct physical access to the APs challenging.

The above-described problems associated with conventional notification/alert mechanisms are addressed by examples of the disclosed technology, which are directed to, e.g., wirelessly, communicating state and failure causes or information indicating state/failure causes to one or more interested entities when an AP is in distress. In particular, examples of the disclosed technology realize technical improvements and advantages by advertising health/status information of an AP (that could identify or reflect the cause of AP failure(s)) in transmitted frames for an existing WLAN or dynamically-spawned WLAN. As noted above, APs may interact with an NMS, and may also interact with various other network elements/entities, such as servers/services, e.g., proxy servers, authentication servers/services, and the like. Accordingly, the advertised health/status information can, in some examples, refer to the operational interfaces (physical or logical) between an AP and an NMS or other network elements, services, etc. A new information element (IE) may be implemented that contains or carries AP health information. The IE may be, e.g., a 16-bit IE that can be included in beacons or probe responses, and consumed by an interested entity (another AP, an application running on a client device, etc.) or system (e.g., the NMS). As will be described in greater detail below, some number of bits of the AP health information IE can be used to signal/identify a relevant state of an AP, e.g., if there is no physical link, if there is a failure at the network layer, etc. Although examples of the disclosed technology are described in the context of distressed APs, if scenarios exist where an AP is unable to communicate its state, but is not necessarily in distress, examples of the disclosed technology may still be used to communicate an AP's state. In some examples, an AP can be configured or enabled to always transmit AP health information vis-à-vis the AP health information IE.

The above-noted AP health information can be communicated by an AP to another AP that can hear or receive a beacon, probe response (or other transmission) sent by the (original) AP, or to another device, e.g., a client device running a third party application capable of digesting AP health information. The transmissions including the AP health information IE can be sent by an AP when that AP is unable to communicate with its NMS, either during initialization of the AP (e.g., after initial bootup) or during runtime (when the AP goes down for some reason). Although APs can operate over different frequency bands, e.g., 2.4/5/6 GHz bands, transmission of AP health information preferably occurs over the 2.4 GHZ band because compared to the 5/6 GHz bands, the 2/4 GHz band has better coverage/penetration. Moreover, most if not all modern APs use at least a 2.4 GHz radio, and thus, no hardware changes to APs are needed, and adoption of examples of the disclosed technology can occur on existing/legacy and future AP platforms. Moreover, in the case of un-provisioned APs, the 2.4 GHz radio of an AP can be used to transmit data in all countries. In contrast, 5 GHz and 6 GHz radios cannot be used/5/6 GHz communications may not commence until a country code (or still other dependencies in the case pf 6 GHz radios) is set. However, it should be understood that the disclosed technology is not limited for use in any particular band. Indeed, in some examples, in the case of provisioned APs, the AP health information IE can be utilized in all WLAN's being broadcast on all radios. This is because some APs can be configured with the 2.4 GHz radio disabled.

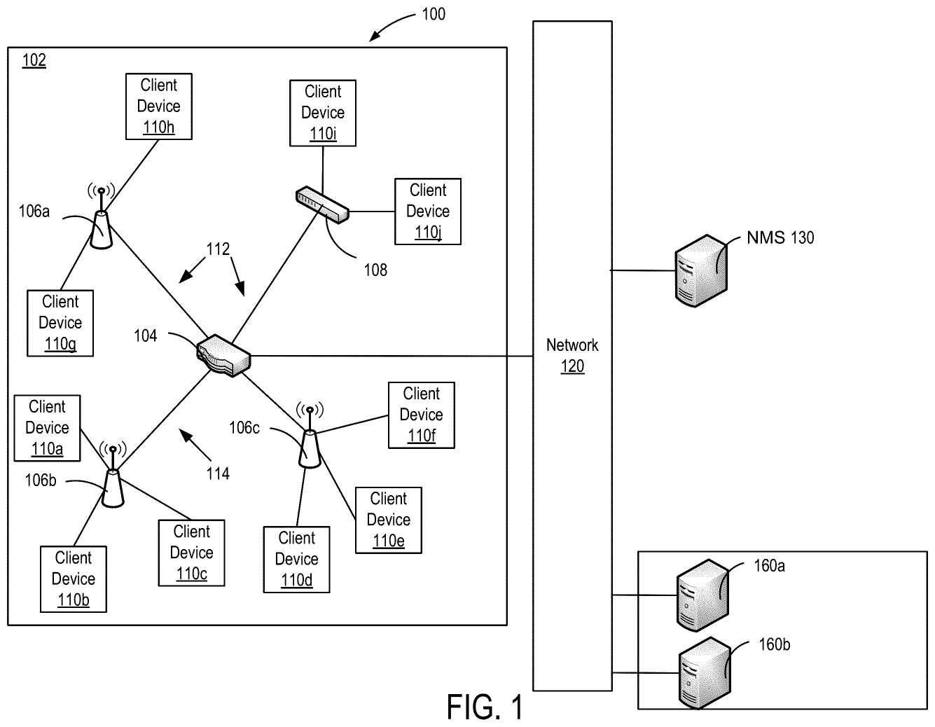

It is useful to describe a network or system within which the aforementioned method of communicating an AP's health information may be implemented. FIG. 1 illustrates one example of a network deployment 100 that may be implemented for an enterprise/organization, such as a business, educational institution, governmental entity, healthcare facility or other organization. This diagram illustrates an example of a configuration implemented with an organization having multiple users (or at least multiple client devices 110) at a geographical site 102.

The geographical site 102 may include a primary network, which can be, for example, an office network, home network or other network installation. The geographical site 102 network may be a private network, such as a network that may include security and access controls to restrict access to authorized users of the private network. Authorized users may include, for example, employees of a company at geographical site 102, residents of a house, customers at a business, and so on. In the illustrated example, the geographical site 102 includes a controller 104 in communication with the network 120. The controller 104 may provide communication with the network 120 for the geographical site 102, though it may not be the only point of communication with the network 120 for the geographical site 102. A single controller 104 is illustrated, though the geographical site 102 may include multiple controllers and/or multiple communication points with network 120. In some examples, the controller 104 communicates with the network 120 through a router (not illustrated). In other examples, the controller 104 provides router functionality to the devices in the geographical site 102.

A controller 104 may be operable to configure and manage network devices, such as at the geographical site 102. The controller 104 may be operable to configure and/or manage switches, routers, access points, and/or client devices connected to a network. The controller 104 may itself be, or provide the functionality of, an access point.

The controller 104 may be in communication with one or more switches 108 and/or wireless Access Points (APs) 106a-c. Switches 108 and wireless APs 106a-c provide network connectivity to various client devices 110a-j. Using a connection to a switch 108 or AP 106a-c, a client device 110a-j may access network resources, including other devices on the (geographical site 102) and the network 120.

Examples of client devices may include: desktop computers, laptop computers, servers, web servers, authentication servers, authentication-authorization-accounting (AAA) servers, Domain Name System (DNS) servers, Dynamic Host Configuration Protocol (DHCP) servers, Internet Protocol (IP) servers, Virtual Private Network (VPN) servers, network policy servers, mainframes, tablet computers, e-readers, netbook computers, televisions and similar monitors (e.g., smart TVs), content receivers, set-top boxes, personal digital assistants (PDAs), mobile phones, smart phones, smart terminals, dumb terminals, virtual terminals, video game consoles, virtual assistants, Internet of Things (IOT) devices, and the like.

Within the geographical site 102, a switch 108 is included as one example of a point of access to the network established in geographical site 102 for wired client devices 110i-j. Client devices 110i-j may connect to the switch 108 and through the switch 108, may be able to access other devices within the network deployment 100. The client devices 110i-j may also be able to access the network 120, through the switch 108. The client devices 110i-j may communicate with the switch 108 over a wired 112 connection. In the illustrated example, the switch 108 communicates with the controller 104 over a wired 112 connection, though this connection may also be wireless.

Wireless APs 106a-c are included as another example of a point of access to the network established in geographical site 102 for client devices 110a-h. Each of APs 106a-c may be a combination of hardware, software, and/or firmware that is configured to provide wireless network connectivity to wireless client devices 110a-h. In the illustrated example, APs 106a-c can be managed and configured by the controller 104. APs 106a-c communicate with the controller 104 and the network over connections 112, which may be either wired or wireless interfaces.

An AP generally refers to a networking device that allows a wireless client device to connect to a wireless network. An AP can include a processor, memory, and I/O interfaces, including wired network interfaces such as IEEE 802.3 Ethernet interfaces, as well as wireless network interfaces such as IEEE 802.11 Wi-Fi interfaces, although examples of the disclosure are not limited to such interfaces. An AP can include memory, including read-write memory (i.e., volatile memory), and a hierarchy of persistent memory (i.e., non-volatile memory) such as ROM, EPROM, and Flash memory. Moreover, as used herein, an AP may refer to receiving points for any known or convenient wireless access technology which may later become known. Specifically, the term AP is not intended to be limited to IEEE 802.11-based APs.

The network 120 may be a public or private network, such as the Internet, or other communication network to allow connectivity with geographical site 102, as well as access to servers 160a-b. The network 120 may include third-party telecommunication lines, such as phone lines, coaxial cable, fiber optic cables, satellite communications, cellular communications, and the like. The network 120 may include any number of intermediate network devices, such as switches, routers, gateways, servers, and/or controllers, which are not directly part of the network deployment 100 but that facilitate communication between the various parts of the network deployment 100, and between the network deployment 100 and other network-connected entities.

NMS 130 may be a server computing device that monitors the health and performance of a network and/or configures devices connected thereto, such as network devices 102 and 104. NMS 130 may further manage and/or deploy a network, such as network 100. Examples of NMS include Aruba® Central™, and Aruba® Airwave™. The connection between NMS 130 and any of the aforementioned network devices may include one or more network segments, transmission technologies, and/or components. NMS 130 may comprise a cloud-based NMS, an on-premises NMS, or a mobility conductor/controller. In some examples, controller 104 may be/act as an NMS, which in the illustrated scenario, may comprise an on-premises instance or implementation of an NMS in geographical site 102.

It should be appreciated that the above-described network devices (client devices 110a-j, switch 108, APs 106a-c, NMS 130, etc.) may be remotely located from one another. As also described above, the physical implementation or installation of a network device, such as one of APs 106a-c, may include installation on a ceiling or other difficult-to-access location, or from the perspective of NMS 130, completely inaccessible by virtue of being remotely located from one another. Accordingly, conventional mechanisms or methods for communicating an APs state or other information/condition, such as failure information, are ill-equipped to provide an NMS with such information.

One example of a conventional approach used to communicate AP information involves the use of light emitting diodes (LEDs). That is, some vendors may implement one or more LEDs on an AP, e.g., on a housing of the AP, or somewhere on the AP that is visible to the human eye. This is so an administrator or installer can visually appreciate, e.g., LED flash patterns or colors/combinations of colors that correspond to certain AP states or information. For example, two LEDs of a plurality of LEDs displaying a blinking red light pattern may suggest the AP is booting up. A single, green non-blinking active LED may suggest the AP is configured by the cloud, whereas two, orange blinking LEDs suggest that the AP is undergoing an upgrade. Still other patterns or colors/color combinations can be used to indicate that an ethernet link is down, or that the AP has no assigned IP address, that mutual authentication failed, etc. However, one has to be able to see these LEDs, and, in many scenarios, that is not possible due to its installation location, for example.

Liquid crystal displays (LCDs) or other visual mechanisms for presenting AP-related information, like the use of LEDs, can fall prey to the same shortcomings, i.e., visual perception of displays, is not possible or very inconvenient in many practical scenarios. Yet another conventional approach relies on Bluetooth® radios to transmit an AP's state information to neighboring APs. The neighboring APs may then relay the received state information to an NMS. However, such an approach is premised on the existence of one or more neighboring APs that is/are in range of the transmitting AP. Such an approach is also premised on the neighboring AP(s) actively communicating with the NMS in order for the received state information to be relayed to NMS. Thus, even the use of Bluetooth-related mechanisms make determining the cause of an AP failure difficult, if not impossible. In fact, not all APs have Bluetooth® radios/capabilities, making reliance on Bluetooth® (or other similar near-field communications mechanisms) problematic.

As alluded to above, examples of the disclosed technology solve a problem rooted in computer technology, i.e., the inability to determine a root cause of an AP failure, by transmitting relevant AP information, e.g., state or failure cause information using radios of an AP. APs can be configured to operate according to different modes, e.g., single-radio or multi-radio modes. It should be understood that in single-radio mode, a single radio operates on a given band, whereas in a multi-radio mode, such as a dual-radio mode, the radio chains of a radio can be grouped while operating on a given band. That is, an AP may be configured to operate using logical or physical radios such that an AP can operate in single-radio mode where a single radio can utilize a given channel bandwidth allocation, e.g., 80 MHz, or in dual-radio mode where the single radio can be split into two radios, each utilizing the same or reduced or higher channel bandwidth allocation. More recently developed APs may comprise multi-band radios that can operate with radio chains in the 5 GHz band or 2.4 GHz band, as well as in the 6 GHz band. As used herein, the term “radio chain” can refer to hardware that can transmit and/or receive information via radio signals. Wireless client devices and/or other wireless devices can communicate with a network device on a communication channel using multiple radio chains. As used herein, the term “communication channel” (or channel) can refer to a frequency or frequency range utilized by a network device to communicate (e.g., transmit and/or receive) information.

Thus, APs, such as APs 106a-c, may be enabled to implement virtual APs (VAPs), namely, support for one or more multiple distinct service set ID (SSID) values over a single AP radio with unique media access control (MAC) addresses per SSID (i.e., a basic SSID (BSSID)). An SSID may be a field between 0 and 32 octets that can be included as an IE within management frames. In the context of the 802.11 standard, management frames supporting the SSID IE include the beacon, probe request/response, and association/reassociation request frames. An AP can support VAPs using multiple BSSIDs. Typically, a beacon or probe response may contain a single SSID IE. The AP sends beacons for each VAP that it supports at a beacon interval (e.g., 100 ms), using a unique BSSID for each VAP. The AP responds to probe requests for supported SSIDs (including a request for the broadcast SSID) with a probe response including the capabilities corresponding to each BSSID. Typically, an AP may advertise up to a given number (e.g., 16) of beacons, each with a different BSSID to provide the VAP support. Each VAP may have a unique MAC address, and each beacon may have a network name.

In particular, the aforementioned AP health information IE containing AP health information, may be included in beacons, probe responses (to probe requests), or other transmissions sent by an AP. Such beacons may be transmitted when an AP is in distress, i.e., in some down/failure state. The bits comprising the AP health information IE can be received by neighboring APs and relayed to the NMS serving or monitoring the AP. It should be noted that APs, such as the neighboring APs, when operative/in an operational state, have an active management/control channel established with the NMS. Thus, APs are typically configured to relay telemetry information, e.g., state information, health information, etc., to the NMS over this active management/control channel, and in accordance with examples of the disclosed technology include the AP health information received from the AP in distress. In some examples, other network devices or client devices that can receive an AP's transmissions, e.g., UXI sensors (a particular type of sensor used for monitoring a network's health and performance) or any Wi-Fi-capable device. In the case of Wi-Fi capable devices, such devices may be running applications that can consume such information, e.g., various network utilities and tools, such as wireless network scanner tools, network analyzers, and the like, some examples of which include Wi-Fi Explorer, Ekahau, Aruba® Utilities™. It should be noted that examples of the disclosed technology may be implemented as a software solution that can be enabled on existing or future indoor/outdoor APs or network devices, and does not suffer from the issues that exist with conventional technologies, such as Bluetooth range issues. It should be noted that the operation of examples of the disclosed technology are transparent and do not impact the operation or use of client devices. That is, some IEs conveyed to client devices cause the client device to behave differently, e.g., some type of configuration or control, such as a Channel Switch Announcement (CSA) element in a beacon, probe response, or action management frame(s) that instructs the client device to move from using one channel to another channel. The AP health information IE, on the other hand, does not cause a client device to operate or act differently. Typical drivers for client devices are written or specified to ignore IEs that are not understood, meaning the AP health information IE can be advertised, and only those devices or applications that can recognize, consume or use the AP health information need decode the IE.

When a distressed AP is still un-provisioned, i.e., the distressed AP has not yet been configured for operation in a network, the distressed AP may dynamically spawn a new WLAN. That is, the distressed AP may advertise or broadcast its SSID name in order to be discoverable by other network devices, such as client devices, effectively creating a new WLAN. When a distressed AP is provisioned and already operational on a network, an existing WLAN (indicated by the distressed AP's first BSSID, for example) can be used for the transmission of AP health information. In scenarios where, for some reason, all of a distressed (and provisioned) AP's WLANs are disabled by an uplink manager, e.g., due to the failure impacting the distressed AP, the AP may spawn a new WLAN, as described above. In this way, the distressed AP can communicate its AP health information regardless of whether it is already provisioned with an established WLAN, or whether it is as-of-yet un-provisioned.

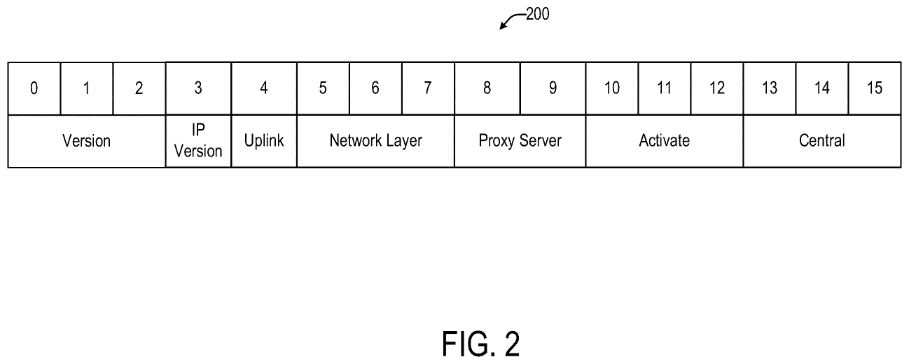

FIG. 2 illustrates an example of an AP health information IE 200 in accordance with one example of the disclosed technology. For ease of consumption, the bits are organized into a sequence of layers that closely match the order of operation, where a failure or some error condition/occurrence generally prevents successful operation(s) at a higher layer. The appropriate number of bits can be allocated to each layer based on common failure states that are to be communicated for each layer.

As illustrated in FIG. 2, three bits (0, 1, 2) can be used to communicate the version, i.e., the version/revision of the implemented fields of AP health information IE 200. Indicating the version information enables a listening device, e.g., a neighboring AP or client device to determine how to decode the bits in AP health information IE 200, while also accounting for any modification(s) or addition(s) to the specified bits, e.g., in the future. For example, the number of bits used to characterize AP health may, in the future, be expanded to 32 bits or 64 bits instead of 16, in order to identify more characteristics of an AP. The version indication will inform a listening device how to decode these new bitsets. It should be noted that this version field can also include bits/bit values reserved for future use, e.g., to account for/accommodate future updates/future versions.

Another bit (3) can be used to communicate the IP Protocol version that the AP prefers when communicating with the NMS. This field can be included to accommodate future dual-stack environments where an AP may prefer either IPv4 or IPv6 addresses. This field aids in root cause determination for issues that may occur at higher layers.

Another bit (4) can be implemented to communicate physical layer issues, i.e., whether or not a communications link, i.e., an uplink, exists. That is, the uplink can be a physical link (E0 or E1, referring to the Ethernet port/interface used for the uplink to the network) or a wireless mesh. The wired/wireless uplink is either present and active, or not.

The next three bits (5, 6, 7) can be implemented to communicate network layer issues. Each AP operates in accordance with an IP address, network mask, default gateway, and name-server information. These three bits can communicate IP addressing failures, missing IP information, and Address Resolution Protocol (ARP)/Neighbor Discovery (ND) default gateway failures. It should be noted that missing IP information bits can serve multiple purposes, e.g., communicating missing static IP configuration information, Dynamic Host Control Protocol (DHCP) options, or Point-to-Point Protocol over Ethernet (PPPOE) information. It is contemplated that the disclosed technology may leverage the use of additional fields for IPV6 addressing failures (IPv6 addresses being 128 bits, whereas IPv4 addresses are 32 bits).

Bits 8 and 9 can be implemented to communicate proxy server authentication and host reachability problems or issues for APs that communicate with their NMS through a proxy server.

The next three bits (10, 11, 12) may be implemented to communicate common Activate failures. It should be understood that “Activate” in this example refers to provisioning (e.g., zero-touch provisioning) and cloud-based inventory management services, such as Aruba® Activate™, typically used for zero-touch provisioning and cloud-based inventory management. These bits can communicate a failure to resolve an Activate fully qualified domain name (FQDN), IP reachability, certificate handshake failures, and missing provisioning due to missing device assignments in an edge-to-cloud platform, such as HPE® GreenLake™.

Similarly, bits 13, 14, and 15 can be implemented to communicate common Aruba® Central™ failures. These bits can communicate failures to resolve assigned Central™ instances of FQDN, IP reachability, certificate handshake failures, and common configuration push issues.

It should be understood that the AP health information IE illustrated and described herein is one example implementation, and can be tailored or customized according. Here, provisions are given to accommodate certain vendor-specific information that may be relevant to AP failures. Moreover, it should be understood that the number of bits allocated or assigned to a particular layer/field of the AP health information IE are based on knowledge of the common failures that may occur for each layer (to provide broadest coverage for failures), although again, the specific make-up of an AP health information IE can vary. Further still, the AP health information IE may be enabled or disabled at the discretion of an administrator or installer, for example.

Below is a table that sets forth values that are programmed for each bit/layer in the AP health information IE. Again, such fields, bits. and corresponding values can vary, or can be customized depending on the needs or desires of a particular user, entity, deployment, etc.

TABLE 1

| Bit | Layer | Value(s) |
|---|---|---|
| 0-2 | Version | 000 = Version 1 |
| | | 001 = Reserved for Future Use |
| | | 001 = Reserved for Future Use |
| | | 010 = Reserved for Future Use |
| | | 011 = Reserved for Future Use |
| | | 100 = Reserved for Future Use |
| | | 101 = Reserved for Future Use |
| | | 110 = Reserved for Future Use |
| | | 111 = Reserved for Future Use |
| 3 | IP Protocol | 0 = IP Version 4 |
| | Version | 1 = IP Version 6 |
| 4 | Uplink | 0 = Uplink |
| | | 1 = No Uplink |
| 5-7 | Network Layer | 000 = Successful |
| | | 001 = No IP Address (DHCP Failure) |
| | | 010 = No IP Address (PPPoE Failure) |
| | | 011 = Missing IP Information |
| | | 100 = Failed ARP/ND for Default Gateway |
| | | 101 = NTP Date & Time Sync Failure |
| | | 110 = Reserved for Future Use |
| | | 111 = Failure at previous layer |
| 8-9 | Proxy Server | 00 = Successful |
| | | 01 = Authentication Failure |
| | | 10 = No Response from Proxy Server |
| | | 11 = Failure at previous layer |
| 10-12 | Activate ™ | 000 = Successful |
| | | 001 = Unable to Resolve A/AAAA |
| | | 010 = Date & Time Sync Failure |
| | | 011 = IP Connection Failure |
| | | 100 = HTTPS Failure (TLS) |
| | | 101 = No Provisioning Rule |
| | | 110 = Upgrading Firmware |
| | | 111 = Failure at previous layer |
| 13-15 | Central ™ | 000 = Successful |
| | | 001 = Unable to Resolve A/AAAA |
| | | 010 = IP Connection Failure |
| | | 011 = HTT{S Failure (TLS) |
| | | 100 = Websocket Failure (WSS) |
| | | 101 = No Configuration Received |
| | | 110 = Dirty Configuration (Rollback) |
| | | 111 = Failure at previous layer |

As noted above, the bits of AP health information IE 200 can be organized into a sequence of layers that closely match the order of operation, where a failure or some error condition/occurrence generally prevents successful operation(s) at a higher layer. Table 1 reflects this order or hierarchy. It can be appreciated, for example, that the assignment of an IP address is a “base” operation, failings of which may not allow for the performance of any subsequent operations. Moreover, taking for example, the network layer aspect of the AP health information IE 200, it can be seen that certain root cause values at the network layer level are reflected, e.g., lack of an IP address (value 001), IP Protocol Version being the third layer in the AP health information IE hierarchy/order. As another example, each of the network layer, proxy server layer, Activate, and Central layers account for “Failure at a previous layer.” That is, when a failure occurs at a lower layer, the bits for any remaining layers are set to all 1s to indicate that a failure at a lower (previous) layer has occurred. With the exception of network time protocol (NTP) time synchronization, all other failures will prevent an AP from communicating with an NMS.

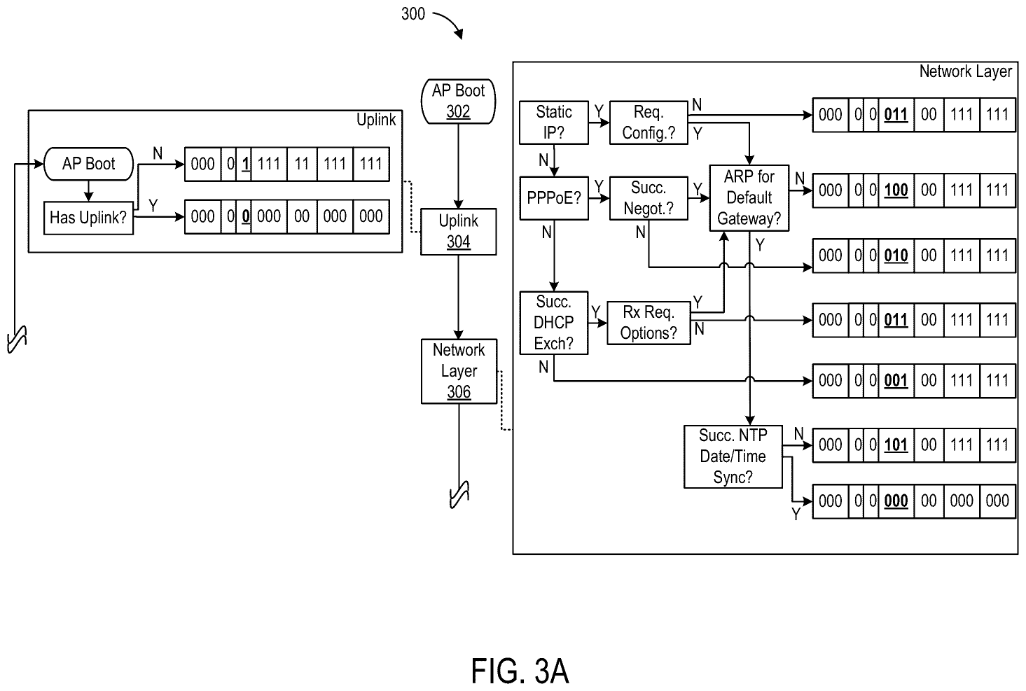

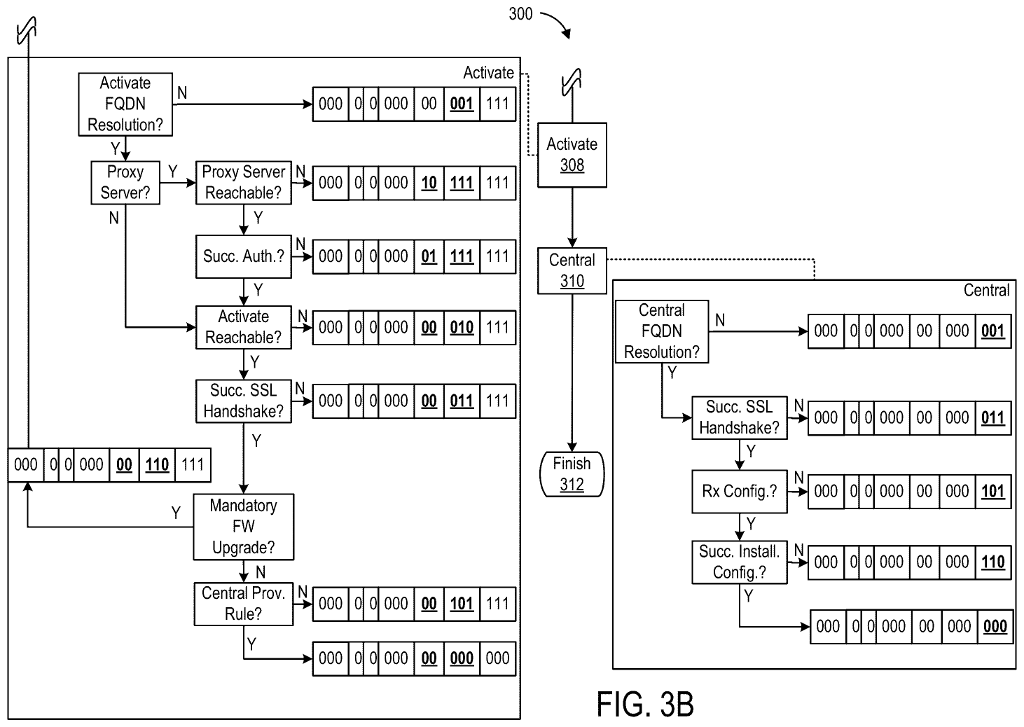

FIGS. 3A and 3B illustrate a method 300 reflecting the logic flow used in accordance with one example of the disclosed technology for setting the bits of layers of the AP health information IE when issues occur during initialization of a (newly deployed) AP. It should be noted that such logic can apply to APs in an un-provisioned or factory default state, as well as Pas in a provisioned/configured state. If an AP undergoing initialization is unable to communicate with an NMS, the AP health information IE can be advertised by the AP with the appropriate bit set, e.g., the AP health information IE can be added to beacons that are being broadcast to advertise the WLAN in addition to other IEs being broadcast in the beacons. Again, a WLAN can be spawned for transmission of the AP health information IE for an un-provisioned AP (or if all WLANs for a provisioned AP have been disabled), and an existing (bridged) WLAN can be utilized.

As illustrated in FIG. 3A, an AP may boot up at 302. Generally, a network device such as an AP may be automatically added to an enterprise's inventory in a cloud-based service, such as Aruba® Activate™ for example, and can be associated with proper provisioning rules for that enterprise. Such an association may be accomplished by placing device information for that particular network device into a folder associated with a desired set of rules to be followed. The network device in a first operating (non-provisioned) state is then factory-shipped to a targeted destination, where a user, e.g., administrator takes the network device out of the box and an event occurs (e.g., power-up and connection to a network; connection to a network; time-based in which a prescribed amount of time has elapsed; or return back to the first operating state). In a “non-provisioned state,” the network device has no configuration settings and has no knowledge of a network device that is operating as its configuration device (e.g., NMS 130 such as AirWave® or a controller, such as control, which may be embodied by, e.g., ARUBA® 7000, 7200 or 9200 controllers). In another operating (provisioned) state, the network device is provided with rules that define how the network device may contact its configuration device to retrieve information, such as firmware and configuration settings and in what configuration group the network device belongs. Furthermore, the rules may be used to automatically assign the network device to specific geographical locations. Upon connection, the network device in the non-provisioned state retrieves its provisioning information from the cloud-based service, and then uses that information to obtain its configuration information from another network device operating as a configuration device, in this example, NMS 130. It should be noted that the relevant version, and preferred IP protocol version can be appropriately specified in the AP health information IE.

At 304, the state of an AP's uplink (physical layer) can be reflected in the bits of the AP health information IE by determining, after AP boot 302, whether or not the AP has an uplink established to the network. If not, the value of the uplink layer bit can be set to 1, but if an uplink is established, the uplink layer bit can be set to 0. As alluded to above, then the uplink does not/does not yet exist, as illustrated in FIG. 3, the corresponding bits of the remaining layers reflects a failure at a previous layer.

At 306, the state of the network layer can be determined and corresponding network layer bits can be assigned values accordingly. For example, a determination can be made regarding whether or not a static IP has been assigned to the AP. If so, a determination is made regarding whether or not configuration is required. If not, the illustrated logic assigns a value to 011 to the network layer bits (5-7). If configuration is required, a determination regarding ARP ability to resolve the MAC address of a default gateway can be made. If the MAC address cannot be resolved, the value of the network layer bits is set to 100 which reflects a failed ARP/ND for the default gateway (as set forth in Table 1). If the MAC address of the default gateway is resolved, a determination can be made regarding whether or not a successful NTP date and time synchronization has occurred. If so, the network layer bits can be set to 000, but if not, the network layer bits can be set to 101. If no static address has been assigned, a determination can be made regarding use of PPPOE, and if PPPOE negotiation is successful (negotiating a direct PPP link to encapsulate IP packets inside of PPP which is then encapsulated inside an Ethernet frame), the determination returns to ARP ability to resolve the MAC address of a default gateway. If negotiation is not successful, the network layer bit can be set to 010 indicating a PPPOE failure. Further determinations can be made if PPPOE is not used, i.e., whether there has been a successful DHCP exchange (if not, the network layer bits can be set to 001). If the DHCP exchange is successful, if required options are received, the determination regarding ARP resolving the default gateway MAC address is revisited, and if the determination is positive, can progress to determining whether a successful NTP date and time synchronization has occurred. If so, as noted above, the network layer bits can be set to 000, but if not, the network layer bits can be set to 110. If the required options are not received, the network layer bits can reflect a value of 011, i.e. IP information is missing.

Referring to FIG. 3B, at 308, regarding the Activate layer, if FQDN resolution is not successful, the Activate layer bits can be set to 001. That is, if FQDN resolution is successful, a determination is made regarding whether not a proxy server is being used to connect to an NMS. If so, but the proxy server is un-reachable, the bits of the Proxy Server/Activate layers can be set to 10111. If, on the other hand, the proxy server is reachable, and authentication with the proxy server is unsuccessful, the bits of Proxy Server/Activate layers can be set to 01111 (indicating that the proxy server is not responding), with the Activate layer indicating failure at the Proxy Server layer. If proxy server authentication is successful, the logic proceeds to determining if the Activate server/service is reachable, and if not, the bits of the Proxy Server/Activate layers can be set to 00010, the “010” bits indicating date and time sync failure. If the proxy server can be reached (proxy server authentication is successful, and the Activate server can be reached), the logic continues to determine if a secure sockets layer (SSL) handshake is successful, and if not, the bits for the Proxy Server/Activate layers are set to 00011. If the SSL handshake is successful, logic proceeds to determining if a mandatory firmware upgrade for the AP is warranted. If so, the Proxy Server/Activate layer bits can be set to 00110. After a firmware upgrade, it should be understood that the logic proceeds back to the AP boot operation 302. If no mandatory firmware upgrade is needed, the logic of method 300 can proceed to determining if NMS (in this example, Central) provisioning rules (sent to the AP by the Activate server/service informing the AP as to which NMS it should connect, as a plurality of NMS instances to which an AP can connect may exist) have been received. If not, the Proxy Server/Activate layer bits can be set to 00101. If NMS provisioning rules have been received by the AP, the AP can specify the Proxy Server/Activate layer bits to be 00000, evidencing that the proxy server is reachable, and the AP has successfully received the provisioning rules from the NMS.

The logic continues to 310, where determinations regarding the Central layer are made. For example, a determination can be made regarding whether or not Central FQDN resolution is successful. If not, the value of the Central layer bits can be set to 001. If Central FQDN resolution is successful, a determination regarding successful SSL handshake is made. If unsuccessful, the Central layer bits can be set to 011. If successful, the logic can progress to determining if a configuration for the AP has been received. If not, the Central layer bits can be set to 101. If successful, the logic can progress to determining whether or not the received configuration was successfully installed (on the AP). If not, the Central layer bits can be set to 110. If installation was successful, the Central layer bits can be set to 000.

Once the above determinations regarding AP state or health have been made, the method 300 can finish at 312.

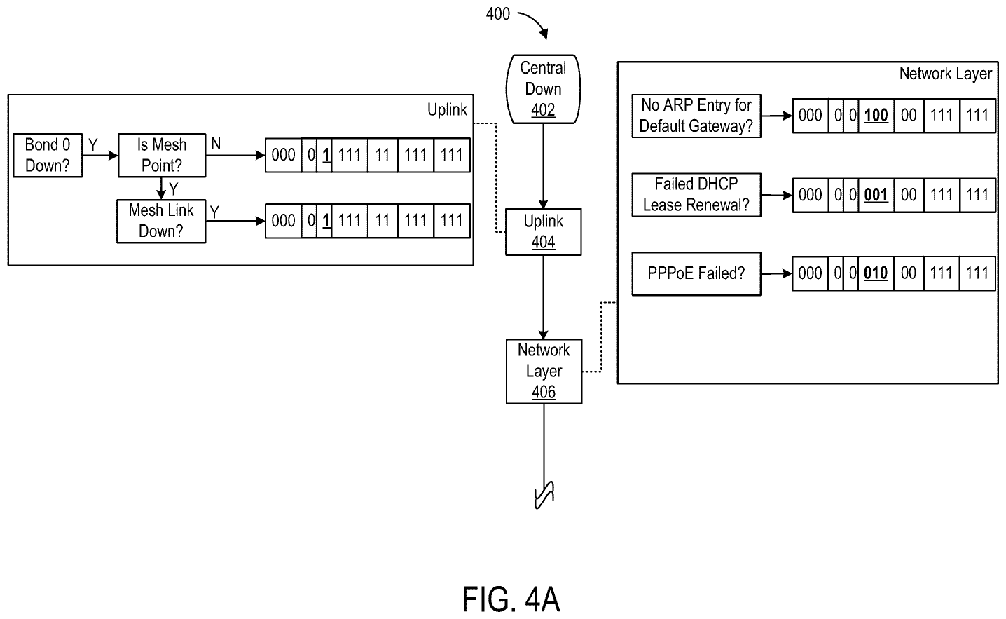

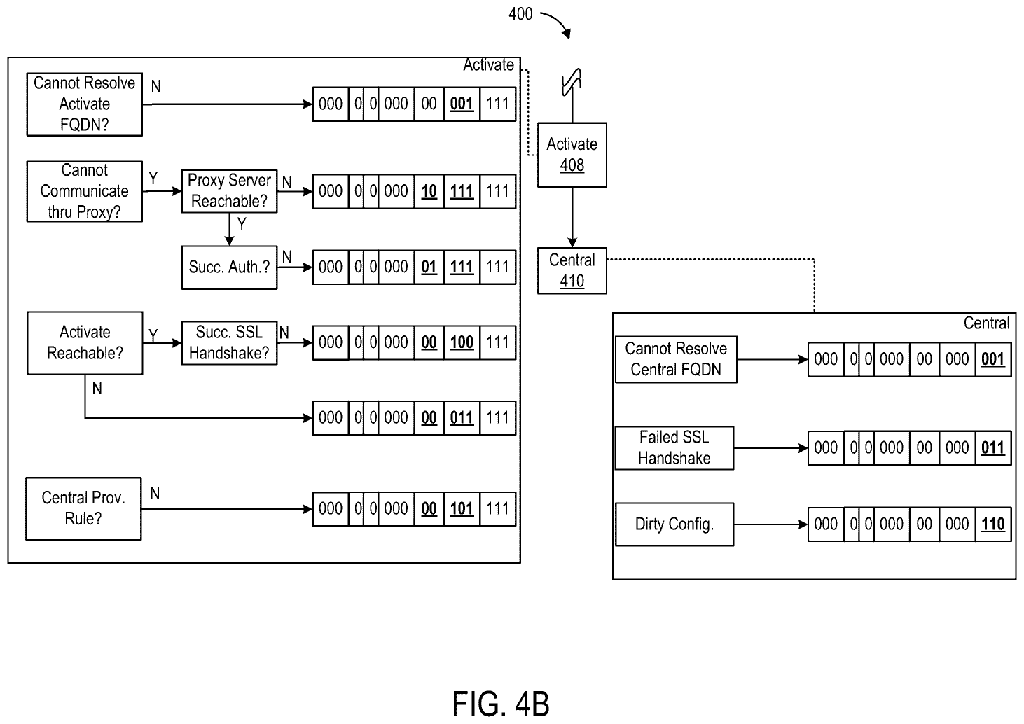

FIGS. 4A and 4B illustrates a method 400 reflecting the logic flow used in accordance with one example of the disclosed technology for setting the bits of layers of the AP health information IE when an AP loses connectivity with the NMS during runtime/while the AP is running, i.e., an already provisioned AP. As alluded to above, the AP health information IE with the appropriate bits/bit values added to an existing, bridged WLAN or advertised on a spawned WLAN.

As illustrated in FIG. 4A, AP connectivity with an NMS (in this example, embodied by Aruba® Central™) associated with the AP may be lost/go down at 402. It should be noted that it is possible that the NMS (Central™) is actually down (which can be determined by the logic of method 400, or that the connection between the AP and NMS is down). Accordingly, at 404, determinations regarding the state of the AP's physical layer, i.e., uplink, may be performed. In particular, a determination is made regarding whether or not the state of the link between the AP and the NMS (Bond 0) is “up” to “down.” If the uplink is down, another determination is made as to whether or not the AP is operating as a mesh point. If not, the Uplink layer bit is set to 1, indicating (per Table 1), that no link exists. If the AP is operating as a mesh point, a determination can be made regarding whether the mesh link is down, and if so, again, the Uplink layer bit is set to 1.

The logic of method 400 continues with determinations regarding operation of the network layer at 406. In particular, when no ARP entry for a default gateway exists, the network layer bits can be set to 100. When DHCP lease renewal has failed, the network layer bits can be set to 001. If PPPOE fails, the network layer bits can be set to 010 indicating the IP information is missing.

Referring to FIG. 4B, the logic of method 400 continues at 408 regarding the Activate layer, where a determination that the Activate FQDN cannot be resolved leads to the bits of the Proxy Server and Activate layers being set to 00001. When a determination is made that the AP cannot communicate through a proxy server, the bits of the Proxy Server and Activate layers can be set to 10111. A failed SSL handshake can result in the bits of the Proxy Server and Activate layers being set to 00011. A lack of Central provisional rules can result in the bits of the Proxy Server and Activate layers being set to 00101. If the AP cannot communicate through a proxy server, a check is performed to determine if the proxy server is even reachable, and if not, the Proxy Server/Activate layer bits can be set to 10111. If the proxy server is reachable, but authentication is not successful, the Proxy Server/Activate layer bits can be set to 01111. If the Activate server is reachable, and if the SSL handshake is successful (as discussed above with respect to FIG. 3), the Proxy Server/Activate layer bits can be set to 00100. If the Activate server cannot be reached, the Proxy Server/Activate layer bits can be set to 00011 indicating an IP connection failure. If the NMS (in this example, Central™) provisioning rules (sent to the AP by the Activate server informing the AP as to which NMS it should connect, as a plurality of NMS instances to which an AP can connect may exist) have not been received by the AP, the Proxy Server/Activate layer bits can be set to 00101.

The logic of method 400 continues to 410, where the results of certain determinations are again used to set bit values. Here, when the Central™ FQDN cannot be resolved, the Central layer bits are set to 001. A failed SSL handshake can result in the bits of the Central layer being set to 011 (indicating a failed IP connection), while existence of a dirty configuration (that as noted above may result in a rollback of the configuration to a previous version per Table 1) corresponds to Central layer bit values of 110.

It should be noted that one of ordinary skill in the art would understand the determinations/logic set forth in FIGS. 3A/3B (and FIGS. 4A/4B), and correspondingly described herein. Again, examples of the disclosed technology are directed to determining root causes of AP failures, and AP operations are understood by those of ordinary skill in the art.

The AP health information made available vis-à-vis the AP health information IE that can be broadcast or advertised via beacons from an AP, for example, can be consumed by neighboring APs, which in turn, can relay that AP health information to the NMS. Applications, such as various networking tools or applications, may also consume AP health information. Alternatively, or in addition to consuming the AP health information, such applications may also relay the AP health information to the NMS. Such applications may be original equipment manufacturer (OEM) applications or they may be third party applications.

Consumption an NMS, as noted above, can occur when an AP that neighbors the AP of interest, i.e., the source of the AP health information, or an application has an active connection to the NMS. That is, the neighboring AP will either see a beacon frame (or other appropriate transmission) while performing off-channel scanning (OCS), or if the neighboring AP happens to resides on the same channel that the AP of interest is operating. In some examples, existing rogue AP detection logic can be leveraged to capture the beacon and relay the AP health information to the NMS.

In order for the NMS to be able to determine which AP in its database of provisioned/registered APs is in destress, the NMS determines the AP's MAC address and/or serial number. Each AP can be assigned a pool of MAC addresses that are derived from the AP's base MAC address. The NMS should then be able to determine the AP's identify from the source MAC address (BSSID) provided in the beacon frame, i.e., the NMS can determine if the received BSSID matches any of the MAC address in the pool of assigned MAC addresses. If additional assistance is needed by the NMS to identify the AP corresponding to the received AP health information, an AP Name IE can also be included in the beacon frame providing another data point for correlation purposes. The AP Name IE will typically include either an assigned hostname (for a provisioned AP), or an AP's base MAC address (for an un-provisioned AP).

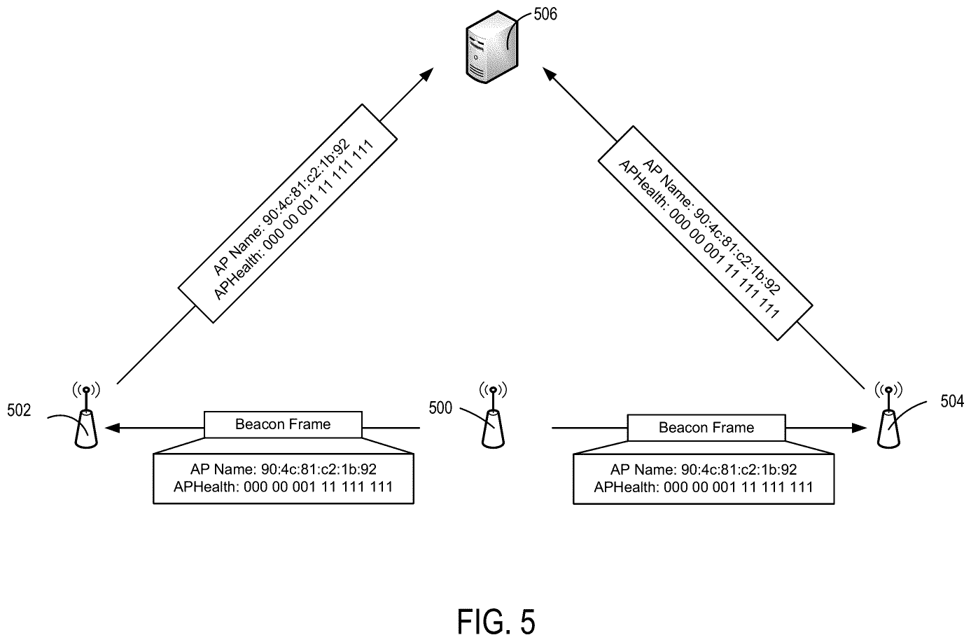

FIG. 5 illustrates a scenario in which a new, un-provisioned AP is in distress (e.g., has failed to obtain an IP address). As discussed above, the un-provisioned AP may spawn a WLAN and proceed to transmit beacon frames that contain the health information of the un-provisioned AP via an AP health IE. As illustrated in FIG. 5, AP 500 may be an un-provisioned AP for which an IP address has not yet been assigned. In accordance with one example of the disclosed technology, AP 500 determines the values of the AP health information IE bits. Here, AP 500 is operating with version 1 . . . , hence the version layer bits are specified as 000. AP 500 prefers to communicate with NMS 506 using IPv4, and an uplink has been established. Accordingly, the IP Protocol Version/Uplink layer bits are 0 and 0. In this example, there an IP address has not been resolved due to a DHCP failure, resulting in the Network Layer field bits being set to a value of 001. The remaining fields, i.e., the Proxy Server, Activate, and Central layers reflect bit values that indicate failure at a previous layer, which is reflected in the AP health information IE as 11 111 111. Thus, as illustrated, the beacon frames transmitted by AP 500 include an AP health information IE with the following bit values “000 0 0 001 11 111 111. The AP health information IE may complement an AP Name IE, which in the illustrated example is 90:4c:81:c2:1b:92. In the illustrated example, two neighboring APs receive the beacon frames transmitted by AP 500, i.e., AP 502 and AP 504. Each of APs 502 and 504 relay/transmit the AP Name and AP health information IEs to NM 506 for consumption. In this way, even though AP 500 is incapable of communicating with NMS 506 itself, its AP health information can be relayed to NMS 506 by neighboring APs, in this example, APs 502 and 504. As discussed above, APs, when in an operational state, have an established communication channel with an NMS over which telemetry data/information is sent to the NMS. In this example AP 500's AP health information is included as a result of the AP health information being received by AP's 502 and 504. Once consumed by NMS 506, appropriate measures can be taken to correct the missing IP information problem of AP 500, if so desired.

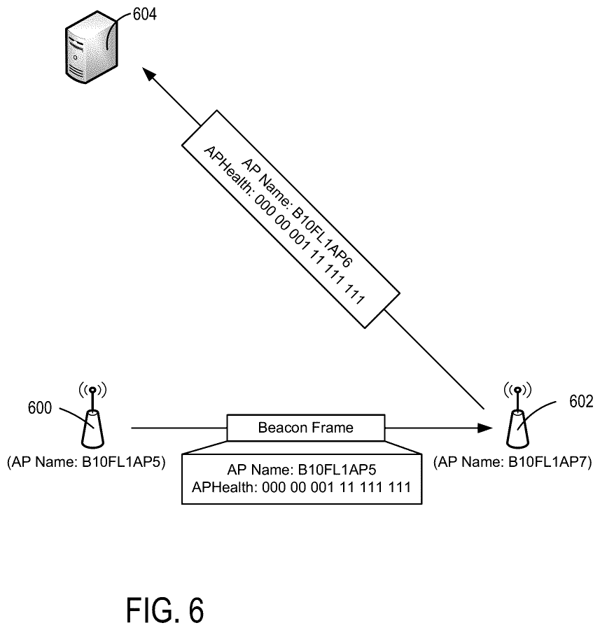

FIG. 6 illustrates a scenario in which an existing/provisioned AP is in distress (e.g., has failed to renew its IP address, e.g., failed DHCP or PPPOE renewal). As discussed above, the existing AP may either use an existing WLAN (BSSID) or spawn a WLAN and proceed to transmit beacon frames that contain the health information of the existing AP via an AP health IE. As illustrated in FIG. 6, AP 600 may be an existing/provisioned AP whose IP address should renew, but the renew failed. In accordance with one example of the disclosed technology, AP 600 determines the values of the AP health information IE bits. Here, AP 600 is operating with version 1 . . . , hence the version layer bits are specified as 000. AP 600 prefers to communicate with NMS 604 using IPv4, and an uplink has been established. Accordingly, the IP Protocol Version/Uplink layer bits are 0 and 0. However, the root cause issue, i.e., failed IP address renewal, is a problem at the network layer resulting from a DHCP failure, and such is reflected in the network layer bits which are set to 001. The remaining proxy server, Activate, and Central layer bits indicate failure at a previous layer, which is reflected in the AP health information IE as 11111111. Thus, as illustrated, the beacon frames transmitted by AP 600 include an AP health information IE with the following bit values “000 0 0 001 11 111 111.” The AP health information IE may complement an AP Name IE, which in the illustrated example is B10FL1AP5. In the illustrated example, a neighboring AP 602 (AP Name B10FL1AP7) AP 602 relays/transmits the AP Name and AP health information IEs to NM 604 for consumption. In this way, even though AP 600 is incapable of communicating with NMS 506046 itself, its AP health information can be relayed to NMS 604 by neighboring APs, in this example, AP 602. Once consumed by NMS 604, appropriate measures can be taken to correct the failed IP renewal problem of AP 600, if so desired.

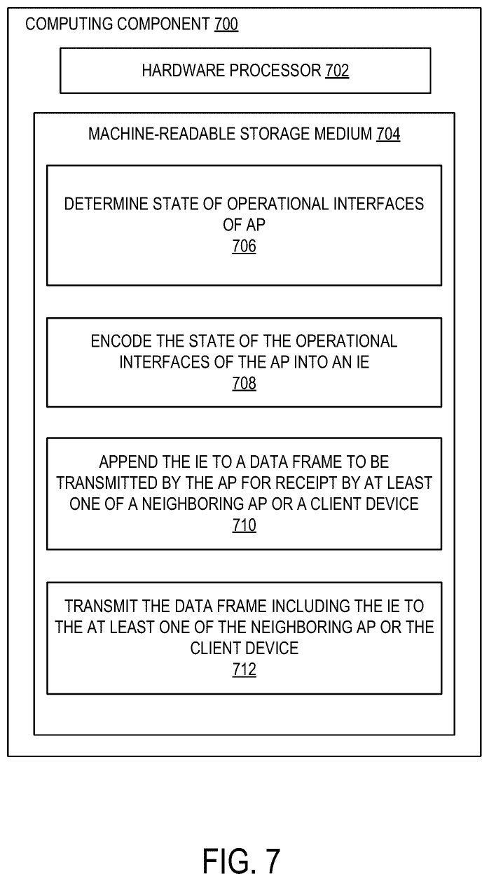

FIG. 7 is a block diagram of an example computing component or device 700 for collecting environmental data proximate to the network device, which may be transmitted along with associated location information in accordance with one embodiment. In the example implementation of FIG. 7, the computing component 700 includes a hardware processor 702, and machine-readable storage medium 704. In some embodiments, computing component 700 may be an embodiment of a network device such as APs 106a-c, switch 108, etc.

Hardware processor 702 may be one or more central processing units (CPUs), semiconductor-based microprocessors, and/or other hardware devices suitable for retrieval and execution of instructions stored in machine-readable storage medium, 704. Hardware processor 702 may fetch, decode, and execute instructions, such as instructions 706-712, to control processes or operations for mutually authenticating device 700 with a corresponding NMS or similar server/network element, and collecting/transmitting environmental and location data. As an alternative or in addition to retrieving and executing instructions, hardware processor 702 may include one or more electronic circuits that include electronic components for performing the functionality of one or more instructions, such as a field programmable gate array (FPGA), application specific integrated circuit (ASIC), or other electronic circuits.

A machine-readable storage medium, such as machine-readable storage medium 704, may be any electronic, magnetic, optical, or other physical storage device that contains or stores executable instructions. Thus, machine-readable storage medium 704 may be, for example, Random Access Memory (RAM), non-volatile RAM (NVRAM), an Electrically Erasable Programmable Read-Only Memory (EEPROM), a storage device, an optical disc, and the like. In some embodiments, machine-readable storage medium 304 may be a non-transitory storage medium, where the term “non-transitory” does not encompass transitory propagating signals. As described in detail below, machine-readable storage medium 704 may be encoded with executable instructions, for example, instructions 706-712. Depending on the implementation, the instructions may include additional, fewer, or alternative instructions, and may be performed in various orders or in parallel.

Hardware processor 702 may execute instruction 706 to determine the state of operational interfaces of an A. As noted above, the health or condition of an AP can be determined by assessing the operational conditions/states of its interfaces. As discussed above, APs may interact with various network entities or devices, such as an NMS, proxy servers, authentication servers/services, and the like. Accordingly, the health of an AP can be characterized based on the state of the operational interfaces (physical or logical) between an AP and an NMS or other network elements, services, etc. Those having ordinary skill in the art know and understand that APs can monitor their various operational interfaces. In other instances, the state of an interface or operating condition of an AP can be ascertained based on whether or not the requisite exchange of data/information occurs, e.g., whether or not an AP receives a response from a proxy server can determine the AP's health from a proxy server perspective.

Hardware processor 702 may execute instruction 708 to encode the state of the operational interfaces of the AP into an IE. As discussed above, various operating conditions/states of interfaces can be encoded to an AP heath information IE, including, for example, proxy server status, network layer status, uplink (physical layer status), and so on. Various bits can be used to represent the state or condition of the various layers set forth in an AP health information IE, and values can be assigned to those various bits to signify different applicable states or conditions. In some cases, a failure at a preceding layer will mean subsequent layers are also in a failed state or condition. As also discussed above, certain methods (e.g., methods 300 and 400) can be used to iterate through the various interfaces/layers/aspects of AP operation to determine the states thereof.

Hardware processor 702 may execute instruction 710 to append the IE to a data frame to be transmitted by the AP for receipt by at least one of a neighboring AP or a client device. In some examples, the data frame may be a beacon. Beacons are used by APs to advertise a WLAN/BSSID, and can be received by/consumed by neighboring APs or client devices. In some examples, the AP health information can be transmitted in or as part of a probe response sent to acknowledge a probe request from a client device. In some examples, the AP health information IE can always be transmitted by an AP so that AP health can be ascertained by an NMS continuously if desired.

Hardware processor 702 may execute instruction 712 to transmit the data frame including the IE to the at least one of the neighboring AP or the client device. It should be understood that the subject AP does not necessarily send the AP health information IE to any target entity (AP or otherwise). Instead, and in accordance with some examples, an AP may advertise a WLAN/BSSID by broadcasting beacons that include AP health information, and any neighboring AP or client device that can hear the beacons can potentially relay the AP Health information gleaned from the beacons to an NMS. In other scenarios, the AP health information IE may be included in a probe response transmitted by an AP replying to a probe request transmitted by client device, in which case, the AP health information IE is sent to a “target” network device. In either case, the AP health information can ultimately be relayed to the NMS, or other device/application intended to consume the AP health information. In turn, the AP may take some form of remediate or corrective action(s) in order to fix the failure/error based on the NMS determining a cause of the failure/error (which as described herein, can be determined based on the AP health information).

For example, the NMS may be aware that an AP cannot communicate with the NMS. However, the NMS cannot determine a cause(s) of this inability to communicate until the NMS analyzes the AP health information to determine that, e.g., the inability to communicate is the result of the lack of a response from a proxy server when the AP attempted to authenticate itself with the proxy server (identified in the AP health information IE in the Proxy Server layer field). Thus, the NMS may take corrective action, e.g., instruct the proxy server to conduct a reset so a subsequent authentication request from the AP will not result in a failure.

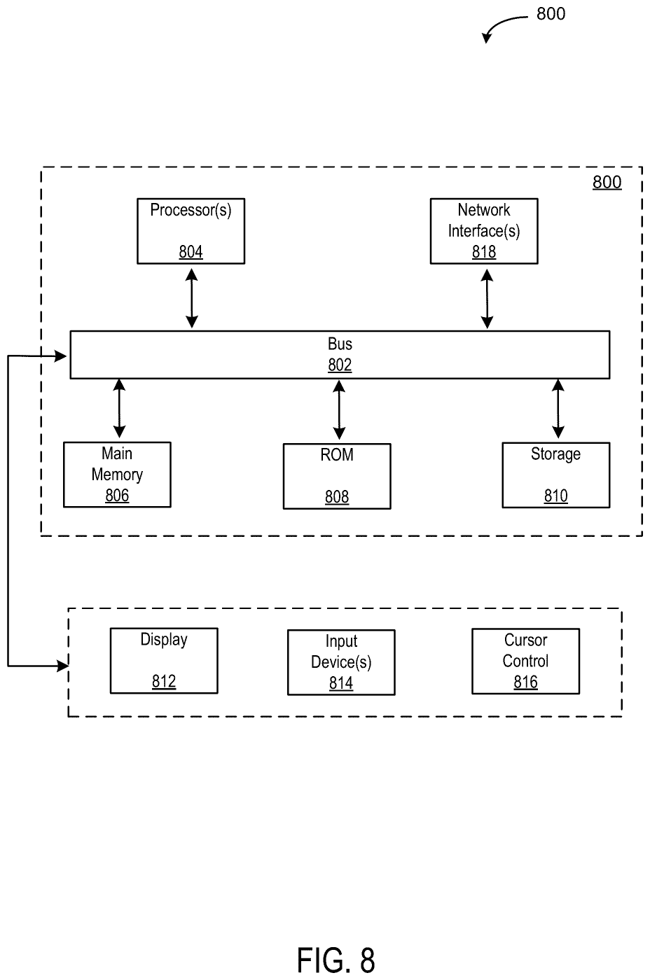

FIG. 8 depicts a block diagram of an example computer system 800 in which various of the embodiments described herein may be implemented. The computer system 800 includes a bus 802 or other communication mechanism for communicating information, one or more hardware processors 804 coupled with bus 802 for processing information. Hardware processor(s) 804 may be, for example, one or more general purpose microprocessors.

The computer system 800 also includes a main memory 806, such as a random access memory (RAM), cache and/or other dynamic storage devices, coupled to bus 802 for storing information and instructions to be executed by processor 804. Main memory 806 also may be used for storing temporary variables or other intermediate information during execution of instructions to be executed by processor 804. Such instructions, when stored in storage media accessible to processor 804, render computer system 800 into a special-purpose machine that is customized to perform the operations specified in the instructions.

The computer system 800 further includes a read only memory (ROM) 808 or other static storage device coupled to bus 802 for storing static information and instructions for processor 804. A storage device 810, such as a magnetic disk, optical disk, or USB thumb drive (Flash drive), etc., is provided and coupled to bus 802 for storing information and instructions.

The computer system 800 may be coupled via bus 802 to a display 812, such as a liquid crystal display (LCD) (or touch screen), for displaying information to a computer user. An input device 814, including alphanumeric and other keys, is coupled to bus 802 for communicating information and command selections to processor 804. Another type of user input device is cursor control 816, such as a mouse, a trackball, or cursor direction keys for communicating direction information and command selections to processor 804 and for controlling cursor movement on display 812. In some embodiments, the same direction information and command selections as cursor control may be implemented via receiving touches on a touch screen without a cursor.

The computing system 800 may include a user interface module to implement a GUI that may be stored in a mass storage device as executable software codes that are executed by the computing device(s). This and other modules may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables.

In general, the word “component,” “system,” “database,” and the like, as used herein, can refer to logic embodied in hardware or firmware, or to a collection of software instructions, possibly having entry and exit points, written in a programming language, such as, for example, Java, C or C++. A software component may be compiled and linked into an executable program, installed in a dynamic link library, or may be written in an interpreted programming language such as, for example, BASIC, Perl, or Python. It will be appreciated that software components may be callable from other components or from themselves, and/or may be invoked in response to detected events or interrupts. Software components configured for execution on computing devices may be provided on a computer readable medium, such as a compact disc, digital video disc, flash drive, magnetic disc, or any other tangible medium, or as a digital download (and may be originally stored in a compressed or installable format that requires installation, decompression or decryption prior to execution). Such software code may be stored, partially or fully, on a memory device of the executing computing device, for execution by the computing device. Software instructions may be embedded in firmware, such as an EPROM. It will be further appreciated that hardware components may be comprised of connected logic units, such as gates and flip-flops, and/or may be comprised of programmable units, such as programmable gate arrays or processors.

The computer system 800 may implement the techniques described herein using customized hard-wired logic, one or more ASICs or FPGAs, firmware and/or program logic which in combination with the computer system causes or programs computer system 800 to be a special-purpose machine. According to one embodiment, the techniques herein are performed by computer system 800 in response to processor(s) 804 executing one or more sequences of one or more instructions contained in main memory 806. Such instructions may be read into main memory 806 from another storage medium, such as storage device 810. Execution of the sequences of instructions contained in main memory 806 causes processor(s) 804 to perform the process steps described herein. In alternative embodiments, hard-wired circuitry may be used in place of or in combination with software instructions.

The term “non-transitory media,” and similar terms, as used herein refers to any media that store data and/or instructions that cause a machine to operate in a specific fashion. Such non-transitory media may comprise non-volatile media and/or volatile media. Non-volatile media includes, for example, optical or magnetic disks, such as storage device 810. Volatile media includes dynamic memory, such as main memory 806. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, and networked versions of the same.

Non-transitory media is distinct from but may be used in conjunction with transmission media. Transmission media participates in transferring information between non-transitory media. For example, transmission media includes coaxial cables, copper wire and fiber optics, including the wires that comprise bus 802. Transmission media can also take the form of acoustic or light waves, such as those generated during radio-wave and infra-red data communications.

As used herein, the term “or” may be construed in either an inclusive or exclusive sense. Moreover, the description of resources, operations, or structures in the singular shall not be read to exclude the plural. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An access point (AP) comprising:
one or more processors; and
a machine readable storage medium storing instructions that, when executed by the one or more processors, cause the AP to:
determine states of operational interfaces of the AP;
encode the states of the operational interfaces of the AP into an information element (IE);
append the IE to a data frame to be transmitted by the AP for receipt by at least one of a neighboring AP or client device; and
transmit the data frame including the IE to the at least one of the neighboring AP or the client device.

2. The AP of claim 1, wherein the instructions that when executed, cause the AP to determine the state of the operational interfaces of the AP further causes the AP to assess an operational state or condition of each of the operational interfaces of the AP in accordance with a hierarchy set forth in the IE.

3. The AP of claim 2, wherein the IE comprises a plurality of fields, each of the plurality of fields corresponding to one of the operational interfaces of the AP.

4. The AP of claim 3, wherein each of the plurality of fields is populated with a number of bits, each of the bits being associated with a value characterizing the health of the operational interfaces.

5. The AP of claim 3, wherein the plurality of fields comprises a version field, an Internet Protocol (IP) version field, a uplink field, a network layer field, a proxy server field, a provisioning services field, and a network management service (NMS) interface field.

6. The AP of claim 1, wherein the data frame comprises a beacon frame.

7. The AP of claim 6, wherein the machine readable storage medium stores further instructions that when executed, cause the AP to advertise a wireless local area network (WLAN) using the beacon frame when the AP is as-of-yet, un-provisioned in a network.

8. The AP of claim 6, wherein the machine readable storage medium stores further instructions that when executed, cause the AP to advertise a wireless local area network (WLAN) using the beacon frame when the AP is already provisioned in an existing, but disabled WLAN.

9. The AP of claim 6, wherein the machine readable storage medium stores further instructions that when executed, cause the AP to transmit the beacon frame in an existing WLAN when the AP is already provisioned in the existing WLAN.

10. The AP of claim 1, wherein the data frame comprises a probe response.

11. The AP of claim 1, wherein the machine readable storage medium stores further instructions that when executed, cause the AP to take correction action in response to a determination by a network management service (NMS) that received the data frame including the IE, the data frame including the IE having been relayed by the at least one of the neighboring AP or the client device to the NMS.

12. An network management system (NMS) comprising:
one or more processors; and
a machine readable storage medium storing instructions that, when executed by the one or more processors, cause the NMS to:
receive health information of a first access point (AP), the health information having been relayed to the NMS by at least one of a second AP or a client device in receipt of the health information from the first AP, the first AP not having a connection to the NMS;
analyze the health information of the first AP;
determine a cause of an operational failure of the first AP based on the analysis of the health information of the first AP;
implement corrective action on the first AP in response to determining the cause of the operational failure of the first AP.

13. The NMS of claim 12, wherein the health information received by the at least one neighboring AP or the client device is received as part of a data frame transmission from the first AP.

14. The NMS of claim 13, wherein the data frame comprises one of a beacon frame or a probe response.

15. The NMS of claim 14, wherein the first AP is not yet provisioned for operation in a network managed by the NMS, and wherein receipt of the health information from the first AP by the at least one neighboring AP or the client device occurs over a wireless local area network (WLAN) spawned based on advertising of the WLAN via the beacon frame.

16. The NMS of claim 14, wherein the machine readable storage medium stores further instructions that when executed cause the NMS to identify the first AP based on a MAC address included in the beacon frame.

17. The NMS of claim 13, wherein the first AP is provisioned for operation in a network managed by the NMS.

18. The NMS of claim 12, wherein the instructions that when executed cause the NMS to analyze the health information of the first AP further causes the NMS to parse an information element (IE) containing the health information of the first AP.

19. The NMS of claim 17, wherein the IE comprises a plurality of fields, each of the plurality of fields corresponding to one of the operational interfaces of the first AP.

20. The NMS of claim 18, wherein each of the plurality of fields is populated with a number of bits, each of the bits being associated with a value characterizing the health of the operational interfaces.
